(19) United States
(12) Patent Application Publication
(10) Pub. No.: US 2008/0196063 A1
(43) Pub. Date: Aug. 14, 2008

(54) METHOD FOR SETTING CONTENTS OF CHANNEL CORRESPONDING TO SPECIFIC PROGRAM CATEGORY, METHOD FOR PLAYING PROGRAMS, AND APPARATUS THEREOF

(76) Inventor: Hsuan-Huei Shih, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/675,077

(22) Filed: Feb. 14, 2007

(51) Int. Cl. H04N 5/445

(52) U.S. Cl. 725/40

(57) ABSTRACT

Methods and apparatus for setting channel contents are provided. A method includes: associating a specific channel with a specific program category; assigning a program to the selected specific channel when the specific channel is selected and the program corresponding to the specific program category is available from a live multimedia stream source; and assigning at least a pre-stored program corresponding to the specific program category from a storage device to the selected specific channel when the specific channel is selected and the program corresponding to the specific program category is unavailable from the live multimedia stream source. Therefore, a user can easily and conveniently watch programs corresponding to a favorite program category on the selected specific channel.

### BACKGROUND OF THE INVENTION

1. Field of the Invention

The invention relates to playing audio/video data, and more particularly, to a method for setting contents of a channel corresponding to a specific program category, a method of playing programs, and apparatus thereof.

2. Description of the Prior Art

Watching television is a common form of entertainment for people nowadays. Fortunately for a viewer, a great variety of programs are available. However, corresponding channel numbers must be remembered correctly, which can present a problem given the huge number of channels available with cable and satellite programming. For instance, if a viewer wants to watch a movie, he has to recall which channel numbers correspond to movie channels. Supposing that the movie channel numbers are 12, 25, and 88, the viewer needs to use a remote control to switch between channels 12, 25 and 88. Furthermore, if the viewer then decides he wants to watch a golf game, he needs to recall which channels show golf games. Supposing that the channels showing golf games are 15, 33, and 42, the viewer needs to switch between channels 15, 33 and 42 to see if a golf game is currently showing. In other words, the viewer needs to remember all channel numbers corresponding to programs he is interested in, which becomes both inconvenient and inefficient.

### SUMMARY OF THE INVENTION

It is therefore one of the objectives of the present invention to provide a method of setting contents of a channel corresponding to a specific program category, a method of playing programs, and apparatus thereof, to solve the above-mentioned problem.

According to an exemplary embodiment of the present invention, a multimedia apparatus for setting channel contents and a method thereof are disclosed. The multimedia apparatus for setting channel contents comprises a storage device and a controlling circuit. The storage device is for storing at least a pre-stored program corresponding to a specific program category. The controlling circuit is coupled to the storage device and a live multimedia stream source, and is for associating a specific channel with the specific program category and assigning programs to the selected specific channel.

The method for setting channel contents comprises associating a specific channel with a specific program category; when the specific channel is selected and a program corresponding to the specific program category is available from a live multimedia stream source, assigning the program to the selected specific channel; and when the specific channel is selected and the program corresponding to the specific program category is unavailable from the live multimedia stream source, assigning at least a pre-stored program corresponding to the specific program category from a storage device to the selected specific channel.

According to another exemplary embodiment of the present invention, a multimedia apparatus for playing programs and a method thereof are also disclosed. The multimedia apparatus for playing programs comprises a storage device, an output device and a controlling circuit. The storage device is for storing at least a pre-stored program corresponding to a specific program category. The controlling circuit is coupled to the storage device, the output device, and a live multimedia stream source, and is for selecting a specific channel associated with the specific program category and assigning programs to the selected specific channel.

The method for playing programs comprises selecting a specific channel associated with a specific program category; when a program corresponding to the specific program category is available from a live multimedia stream source, playing the program on the selected specific channel; and when the program corresponding to the specific program category is unavailable from the live multimedia stream source, playing at least a pre-stored program corresponding to the specific program category from a storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram illustrating a multimedia apparatus according to an exemplary embodiment of the present invention.

FIG. 2 is a simplified block diagram illustrating a multimedia apparatus according to another exemplary embodiment of the present invention.

FIG. 3 is a flowchart illustrating an exemplary embodiment of a method of setting and playing channel contents according to the present invention.

### DETAILED DESCRIPTION

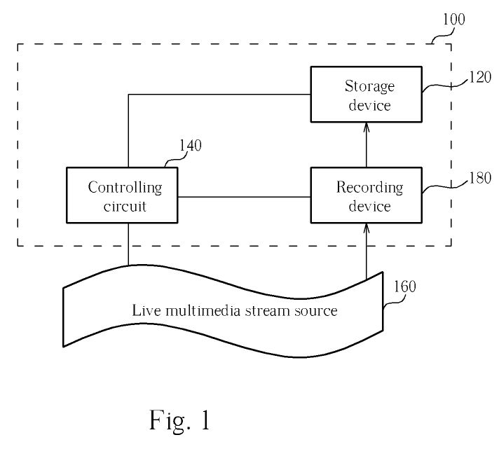

Please refer to FIG. 1. FIG. 1 is a simplified block diagram illustrating a multimedia apparatus 100 according to an exemplary embodiment of the present invention. As shown in FIG. 1, the multimedia apparatus 100 comprises, but is not limited to, a storage device 120, a controlling circuit 140, and a recording device 180. The multimedia apparatus 100 is utilized for setting channel contents. The controlling circuit 140 is coupled to the storage device 120 and a live multimedia stream source 160. For example, the live multimedia stream source 160 could be a Digital TV (DTV) service provider or an Internet Protocol TV (IPTV) service provider. The controlling circuit 140 is utilized for associating a specific channel with a specific program category and assigning programs to the selected specific channel. The specific program category could be a golf category, a classic music category, a Japanese drama category, and so forth. The storage device 120 is utilized for storing at least a pre-stored program corresponding to the specific program category. This means, if the specific program category is selected to be a golf category, the program pre-stored in the storage device 120 is a program related to golf games or programs about golf. The further operations and implementations of the multimedia apparatus 100 will be explained in the following. It should be noted that the following exemplary embodiments are for illustrative purposes only and are not meant to be taken as limitations of the present invention.

When the specific channel is selected and a program corresponding to the specific program category is available from the live multimedia stream source 160, the controlling circuit 140 assigns the program to the selected specific channel; on the other hand, when the specific channel is selected and a program corresponding to the specific program category is unavailable from the live multimedia stream source 160, the controlling circuit 140 assigns a pre-stored program corresponding to the specific program category from the storage device 120 to the selected specific channel. In this embodiment, the multimedia apparatus 100 is configured as a set-top box for setting the channel contents of a selected specific channel to be played on a display screen of a television, a PC monitor, or the like (not shown). For example, if a specific channel is set to be associated with a golf category, the controlling circuit 140 in the multimedia apparatus 100 (e.g. a set-top box) will determine if any TV program related to golf is available according to an electronic program guide (EPG). Please note that using the EPG to check the availability of programs corresponding to a specific program category is merely an example, and not a limitation, of the present invention. When the specific channel is selected and an available TV program related to golf is determined, the multimedia apparatus 100 (e.g. a set-top box) receives the available TV program from the live multimedia stream source 160, and the controlling circuit 140 directs the available TV program to a display device such as a display screen on a television or PC monitor.

The selected specific channel mentioned above is preferably a virtual channel configured to comprise a plurality of physical channels of the live multimedia stream source 160. For example, the selected virtual channel is assigned to play TV programs related to golf and transmitted via any of the physical sports channels configured in the virtual channel; on the other hand, when the virtual channel is selected and no available TV program related to golf is found, the controlling circuit 140 will have a golf-related program pre-stored in the storage device 120 and played on the display device (e.g. the display screen of the television). It should be noted that if there are programs available on multiple physical channels defined in the virtual channel when the virtual channel is selected, the controlling circuit 140 chooses one of the available programs to be played according to design requirements. Moreover, in one case where the association between each specific program category and physical channel can be programmed in the controlling circuit 140 before the multimedia apparatus 100 is shipped to the market, the user can create a virtual channel by assigning a specific program category selected from available pre-defined program categories. However, in another case where the virtual channels are programmed in the controlling circuit 140 before the multimedia apparatus 100 is shipped to the market, the user can immediately use the functionality disclosed above without needing to know how to properly set the virtual channels.

In addition, when the specific channel is selected and a program corresponding to the specific program category is unavailable from the live multimedia stream source 160, the controlling circuit 140 selects a pre-stored program from a plurality of pre-stored programs in the storage device 120 according to play lengths of the pre-stored programs and the EPG, and then assigns the pre-stored program to the selected specific channel. In this embodiment, the controlling circuit 140 in the multimedia apparatus 100 (e.g. set-top box) is able to know when there are TV programs related to the specific program category according to the EPG, so the controlling circuit 140 can also know the length of time that there will be no TV programs related to the specific program category according to the EPG. For example, from 3:00 P.M. to 5:00 P.M. there is no TV program related to golf available from the live multimedia stream source 160. In other words, there is no available TV program related to golf to be played on the display device (e.g. the screen of the television) for two hours. Therefore, the controlling circuit 140 will check play lengths of the pre-stored programs in the storage device 120. In this way, the controlling circuit 140 may have one pre-stored program having the play length of two hours that can be played on the display device (e.g. the television screen). In another case, the controlling circuit 140 may have two pre-stored programs, each of which has a play length of one hour, that can be played on the display device sequentially. In yet another case, the controlling circuit 140 may have three pre-stored programs, of which the play lengths are one hour, a half hour and a half hour respectively, that can be played on the display device sequentially. In summary, the total play length of the combination of the pre-stored programs to be played from 3:00 P.M. to 5:00 P.M. has to be at least two hours. In this way, whenever the user selects the specific channel associated with a specific program category (e.g. the aforementioned virtual channel), the multimedia apparatus 100 can guarantee that the user can watch programs corresponding to the specific program category by playing program contents received from the live multimedia stream source 160 on the display device or playing pre-recorded program contents from the storage device 120 on the display device.

Please refer to FIG. 1 again. The multimedia apparatus 100 further comprises a recording device 180. The recording device 180 is coupled to the controlling circuit 140, the storage device 120, and the live multimedia stream source 160. In this embodiment, the combination of the recording device 180 and the storage device 120 can be implemented by a typical personal video recorder (PVR). The recording device 180 controlled by the controlling circuit 140 is utilized for recording a program into the storage device as one pre-stored program corresponding to the specific program category while a program from the live multimedia stream source 160 is being played when the desired specific channel (e.g. the virtual channel) is currently selected, or is being delivered when the desired specific channel is not currently selected. For instance, according to the EPG, from 5:00 P.M. to 6:00 P.M. there is a TV program related to golf available from the live multimedia stream source 160. Therefore, the controlling circuit 140 can control the recording device 180 to automatically schedule the recording of the TV program delivered from 5:00 P.M. to 6:00 P.M. even if the user does not select the specific channel during this time period. The controlling circuit 140 controls the recording device 180 to record the TV program related to golf into the storage device 120 while the TV program is being played/delivered from 5:00 P.M. to 6:00 P.M. The next time a golf-related program is needed when there is no TV program related to golf available from the live multimedia stream source 160, the recorded and saved program can be used.

In the above description, the “program” stands for a TV program; however, the same concept can be applied to other types of programs. For example, in another embodiment, the multimedia apparatus 200 is applied to audio broadcasting; therefore, the program is an audio broadcasting program. This also obeys the spirit of the present invention.

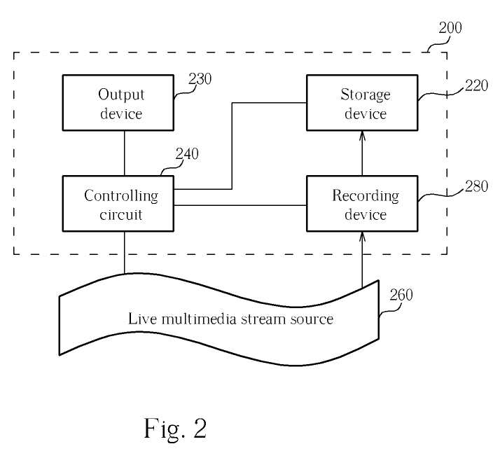

Please refer to FIG. 2. FIG. 2 is a simplified block diagram illustrating a multimedia apparatus 200 according to another exemplary embodiment of the present invention. As shown in FIG. 2, the multimedia apparatus 200 comprises a storage device 220, an output device 230, a controlling circuit 240, and a recording device 280. Compared to the multimedia apparatus 100 shown in FIG. 1, the multimedia apparatus 200 shown in FIG. 2 is able to set channel contents and then play the channel contents. The controlling circuit 240 is coupled to the storage device 220, the output device 230 and a live multimedia stream source 260. The controlling circuit 240 is utilized for selecting a specific channel with a specific program category and controlling the output device 230 to play the program on the selected specific channel. The specific program category could be a golf category, a classic music category, a japanese drama category, and so forth. The storage device 220 is utilized for storing at least a pre-stored program corresponding to the specific program category. This means, if the specific program category is defined to be a golf category, the program pre-stored in the storage device 220 is a program related to golf. Because operations and functions of the elements of the multimedia apparatus 200 shown in FIG. 2 are similar to elements with the same name in the multimedia apparatus 100 in FIG. 1, further descriptions are not detailed here for the sake of brevity. The major difference between the multimedia apparatus 100 and the multimedia apparatus 200 is that the multimedia apparatus 200 is equipped with the capability of playing the contents of the selected specific channel (e.g. the aforementioned virtual channel).

Some exemplary configurations are given as below; however, these are for illustrative purposes only. In one embodiment, the multimedia apparatus 200 could be a television (e.g. a DTV or IPTV) having the output device 230 acting as a typical display screen and a combination of the storage device 220 and the recording device 280 acting as an internal personal video recorder (PVR). In an alternative design, a television (e.g. a DTV or IPTV) can implement the output device 230 and the controlling circuit 240, and an external personal video recorder (PVR) is adopted to implement the storage device 220 and the recording device 280.

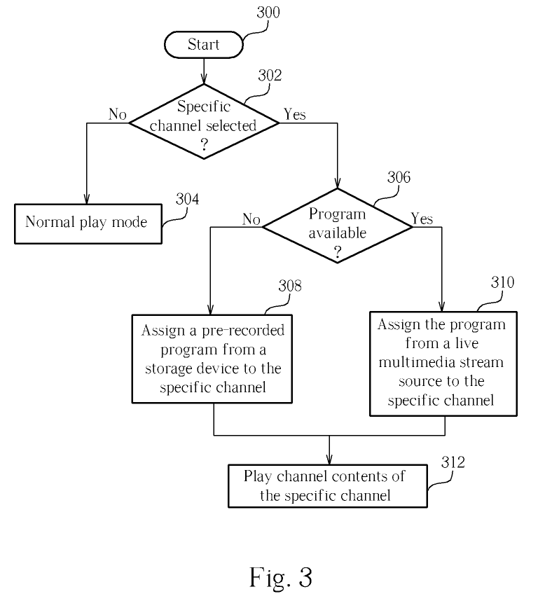

Please refer to FIG. 3. FIG. 3 is a flowchart illustrating an exemplary embodiment of a method of setting and playing channel contents according to the present invention. The method is summarized as below:

Step 300: Start.

Step 302: Is a specific channel (e.g. a virtual channel) selected? If yes, go to step 304; otherwise, go to step 306.

Step 304: Play the channel contents of a typical channel tuned by the user according to a normal play mode.

Step 306: Is a program corresponding to a specific program category associated with the specific channel available from a live multimedia stream source? If yes, go to step 310; otherwise, go to step 308.

Step 308: Assign a pre-recorded program from a storage device to be channel contents of the specific channel. Go to step 312.

Step 310: Assign the program available from the live multimedia stream source to be channel contents of the specific channel.

Step 312: Play the channel contents of the specific channel on an output device (e.g. a display screen of a television or PC monitor).

After reading the above descriptions related to the multimedia apparatus 100 and 200, a skilled person can readily understand operations of the steps in the flow chart shown in FIG. 3. Therefore, further description is omitted here for the sake of brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for setting channel contents, comprising:
associating a specific channel with a specific program category;
when the specific channel is selected and a program corresponding to the specific program category is available from a live multimedia stream source, assigning the program to the selected specific channel; and
when the specific channel is selected and the program corresponding to the specific program category is unavailable from the live multimedia stream source, assigning at least a pre-stored program corresponding to the specific program category from a storage device to the selected specific channel.

2. The method of claim 1, further comprising:
recording the program into the storage device as one pre-stored program corresponding to the specific program category while the program is being played or delivered.

3. The method of claim 2, wherein the specific channel is a virtual channel comprising a plurality of physical channels of the live multimedia stream source; and the step of assigning the program to the selected specific channel comprises:
if the program corresponding to the specific program category is available from at least one of the physical channels, assigning the program to the selected virtual channel.

4. The method of claim 3, further comprising:
according to an electronic program guide (EPG), determining whether the program is available from at least one of the physical channels.

5. The method of claim 1, further comprising:
according to an electronic program guide (EPG), determining whether the program is available from the live multimedia stream source.

6. The method of claim 5, wherein the step of assigning the pre-stored program to the selected specific channel comprises:
when the specific channel is selected and the program corresponding to the specific program category is unavailable from the live multimedia stream source, selecting the pre-stored program out of a plurality of pre-stored programs in the storage device according to play lengths of the pre-stored programs and the EPG, and then assigning the pre-stored program to the selected specific channel.

7. The method of claim 1, wherein the program is a TV program.

8. The method of claim 1, wherein the program is an audio broadcasting program.

9. A multimedia apparatus for setting channel contents, comprising:
a storage device, storing at least a pre-stored program corresponding to a specific program category; and
a controlling circuit, coupled to the storage device and a live multimedia stream source, for associating a specific channel with the specific program category, wherein when the specific channel is selected and a program corresponding to the specific program category is available from a live multimedia stream source, the controlling circuit assigns the program to the selected specific channel; and when the specific channel is selected and the program corresponding to the specific program category is unavailable from the live multimedia stream source, the controlling circuit assigns at least the pre-stored program corresponding to the specific program category from the storage device to the selected specific channel.

10. The multimedia apparatus of claim 9, further comprising:
a recording device, coupled to the controlling circuit, the storage device, and the live multimedia stream source, the recording device controlled by the controlling circuit for recording the program into the storage device as one pre-stored program corresponding to the specific program category while the program is being played or delivered.

11. The multimedia apparatus of claim 10, wherein the specific channel is a virtual channel comprising a plurality of physical channels of the live multimedia stream source; and if the program corresponding to the specific program category is available from at least one of the physical channels, the controlling circuit assigns the program to the selected virtual channel.

12. The multimedia apparatus of claim 11, wherein the controlling circuit determines whether the program is available from at least one of the physical channels according to an electronic program guide (EPG).

13. The multimedia apparatus of claim 9, wherein the controlling circuit determines whether the program is available from the live multimedia stream source according to an electronic program guide (EPG).

14. The multimedia apparatus of claim 13, wherein when the specific channel is selected and the program corresponding to the specific program category is unavailable from the live multimedia stream source, the controlling circuit selects the pre-stored program out of a plurality of pre-stored programs in the storage device according to play lengths of the pre-stored programs and the EPG, and then assigns the pre-stored program to the selected specific channel.

15. The multimedia apparatus of claim 9, wherein the program is a TV program.

16. The multimedia apparatus of claim 9, wherein the program is an audio broadcasting program.

17. A method for playing programs, comprising:
selecting a specific channel associated with a specific program category;
when a program corresponding to the specific program category is available from a live multimedia stream source, playing the program on the selected specific channel; and
when the program corresponding to the specific program category is unavailable from the live multimedia stream source, playing at least a pre-stored program corresponding to the specific program category from a storage device.

18. A multimedia apparatus for playing programs, comprising:
a storage device, storing at least a pre-stored program corresponding to a specific program category;
an output device; and
a controlling circuit, coupled to the storage device, the output device, and a live multimedia stream source, for selecting a specific channel associated with the specific program category, wherein when a program corresponding to the specific program category is available from the live multimedia stream source, the controlling circuit controls the output device to play the program on the selected specific channel; and when the program corresponding to the specific program category is unavailable from the live multimedia stream source, the controlling circuit controls the output device to play at least the pre-stored program from the storage device.
